(19) United States
(12) Patent Application Publication
(10) Pub. No.: US 2013/0276760 A1
(43) Pub. Date: Oct. 24, 2013

(54) FUEL INJECTION SYSTEM COMPRISING A HIGH-PRESSURE FUEL INJECTION PUMP

(71) Applicant: Sergi Yudanov, Vastra Frolunda (SE)

(72) Inventor: Sergi Yudanov, Vastra Frolunda (SE)

(73) Assignee: VOLVO LASTVAGNAR AB, Göteborg (SE)

(21) Appl. No.: 13/996,606

(22) PCT Filed: Dec. 22, 2010
(86) PCT No.: PCT/SE2010/000314

§ 371 Date: Jul. 3, 2013

(51) Int. Cl. F02M 55/00

(52) U.S. Cl. CPC F02M 55/007
USPC 123/506

(57) ABSTRACT

A high-pressure fuel injection pump for pressurizing fuel and delivering it for injection into a internal combustion engine is provided. The high-pressure fuel injection pump has an inlet, at least one plunger and a suction channel positioned between the inlet and the at least one plunger, wherein at least a part of the suction channel is thermally insulated from the remaining part of the high-pressure fuel injection pump. A fuel injection system including such a high-pressure fuel injection pump is also provided. Alternatively to, or in combination with, the thermal insulation of the suction channel, a bleed valve can be connectively arranged at the suction channel of the high-pressure fuel injection pump.

### BACKGROUND AND SUMMARY

The invention relates , according to an aspect thereof, to a high-pressure fuel injection pump and to a fuel injection system comprising a high-pressure filet injection pump.

Such high-pressure fuel injection pumps and fuel injection systems comprising such pumps are normally used for pressurizing fuel and for delivering it for injection into an internal combustion engine.

Rising prices of crude oil-derived fuels and fears of its imminent shortages have in recent years led to further developments in production processes of alternative fuels and internal combustion engines for their use. One of the potentially important alternative fuels that can be effectively produced from a variety of stocks including biomass is dimethyl ether (DME). DME, with its soot-free combustion and high cetane number, is very well suited for diesel-type internal combustion processes. However, DME has a relatively high volatility (compared with normal diesel fuel) and, therefore, has to be pressurized to approximately 5 bar in order to be liquid at room temperature. There are a number of advantages of having fuel supplied in liquid form for injection into a diesel-type internal combustion engine, and thus fuel injection equipment (FIE) suited for DME or other similarly volatile fuel should be specially designed to prevent unwanted vaporization of the fuel.

High-volatility fuels can be prevented from boiling by selecting a higher pressure and/or lower the operating temperature. In a particular application, a suitable combination of pressure and temperature that will provide for an operation of the fuel injection system with a tolerable level of unwanted vapour formation of the fuel must be found to assure minimum possible system cost and complexity. For example, choosing a operating pressure for the fuel tanks and the feed pressure part of the system that is too low for the selected fuel could necessitate the installation of fuel cooling means and would thereby raise cost and complexity of the entire system; on the other hand, trying to solve fuel evaporation problems only by designing the system for higher pressure would also result in more expensive and heavier design solutions.

Considering the fuel temperature part of the problem, it is important to observe that control of local fuel temperatures is equally important to that of the average temperature of the fuel supply and injection system. This is partly because of the fact that evaporation is normally faster than liquefaction and that the vapour cavity, once formed, can travel a long way through the system finally getting into a spot where it is least wanted, usually the suction port of a pump. If that pump is a high-pressure fuel injection pump delivering highly pressurized fuel to the injectors of the internal combustion engine, then an immediate loss of engine power is the result.

To get rid of hot spots in the fuel supply and injection system, in particular in that part of the system (i.e. the fuel feed pressure subsystem) that is supposed to deliver liquid, fuel at the right pressure to the inlet of the high-pressure fuel injection pump, a forced re-circulation of the fuel can be organized in the fuel feed pressure subsystem. This way, the feed pump of the fuel feed pressure subsystem supplies an excess flow of fuel (that exceeds the amount of fuel that is momentarily needed for the combustion process in the internal combustion engine) which by-passes the high-pressure fuel injection pump and, through a restriction, returns to the fuel tank and/or the inlet of the feed pump of the fuel feed pressure system. The higher the excess flow of fuel, the less the risk of hot-spot appearance at which vaporization can take place.

This approach generally works well, but the possibilities of configuring the system for the forced re-circulation to take full effect, can be somewhat limited by the design of the high-pressure fuel injection pump. This is especially true for the inlet-metered type of multi-plunger high-pressure fuel injection pumps that usually feature a single inlet-metering valve (IMV) for controlling the output of the pump. The function of the IMV is to restrict the feed flow to the plungers when partial output is required, by which means injection pressure control is achieved. This type of high-pressure fuel injection pump is widely used on the grounds of its relative simplicity as compared to variable-displacement pumps, allowing effective fuel injection pressure control without wasteful by-passing of highly pressurized fuel that is accepted in some systems with fixed plunger displacement.

When an inlet-metered high-pressure fuel injection pump is used, a limitation for effective fuel re-circulation in the entire low-pressure fuel feed pressure subsystem up to the plunger inlet of the high-pressure fuel injection pump is caused by the need of distributing the output of the single IMV of the high-pressure fuel injection pump to a plurality of pumping plungers in the pump. In the resulting suction volume downstream of the IMV, the pressure would need to be lower than in the rest of the fuel feed pressure subsystem in order to achieve high-pressure flow output control of the high-pressure fuel injection pump. To make matters worse, that suction volume would normally be located in the high-pressure fuel injection pump which runs at relatively high temperatures, being arranged in the dose vicinity of the internal combustion engine or even directly flange-mounted to it. The combination of warm surroundings and a drop in fuel pressure can under certain conditions cause uncontrolled evaporation of the fuel in the suction volume and subsequent pump fuel delivery disruption.

This phenomenon would be especially prominent in situations where the internal combustion engine is hot and operated under part load conditions where a relatively small through-flow of fuel in the suction volume is required. In such a case, the fuel exchange in the suction volume would be slow, and the plungers of the high-pressure fuel injection pump would also process any existing vapour cavities more slowly compared with a situation where a high delivery of fuel is required from the high-pressure fuel injection pump to the injectors of the internal combustion engine. A way of dealing with this problem, which is known in the art, is the reduction of the suction volume. This would increase the rate of fuel exchange in that suction volume for a given through-flow of fuel and therefore would help to keep its temperature under control, and would eventually also limit the amount of uncontrollably formed vapour cavities that have to be liquefied by the plungers of the pump. However, the possibilities for such a suction volume reduction are limited (i) by the need to ensure adequate now area of the passages from the IMV to the plungers of the high-pressure fuel injection pump for full output conditions and (ii) by packaging and technological considerations, as e.g. the IMV sometimes cannot be positioned very close to the plunger inlets.

It is desirable to provide a high-pressure fuel injection pump and a fuel injection system comprising a high-pressure fuel injection pump that are less vulnerable to vapour formation of the fuel.

It is also desirable to provide a high-pressure fuel injection pump and a fuel injection system that are suited for processing high-volatility fuels, as for instance DME, for internal combustion engines.

One general advantage of an aspect of the invention is that it reduces the amounts of vapour formation of the fuel to be pressurized by the high-pressure fuel injection pump thereby reducing correspondingly the risk that the delivery of pressurized fuel by the high-pressure fuel injection pump for injection into the internal combustion engine is reduced below the amount of fuel needed for the actual operation of the engine and at the same time enhancing the reliability and robustness of the control of said delivery of pressurized fuel for injection into the internal combustion engine.

According to a first aspect of the invention, a high-pressure fuel injection pump for pressurizing fuel and delivering it for injection into an internal combustion engine is proposed, wherein said high-pressure fuel injection primp comprises an inlet (for receiving fuel from e.g. a fuel tank), at least one plunger (that pressurizes the received fuel and delivers it to injectors for injection into the internal combustion engine) and a suction channel positioned between the inlet and the at least one plunger (thereby connecting the inlet of the high-pressure fuel injection pump with the inlet port of the at least one plunger). To ensure reliable control of fuel density at the inlet port of the plunger and thus maintain pump output controllability, according to this first aspect of the invention at least a part of the suction channel is thermally insulated from the remaining part of said high-pressure fuel injection pump.

In a preferred embodiment of an aspect of the invention, a sleeve is inserted in the high-pressure fuel injection pump in such a way that the inner diameter of said sleeve forms at least a part of said suction channel. Advantageously, the sleeve is made of a material whose thermal conductivity is much lower than the thermal conductivity of the material of at least the part of the high-pressure fuel injection pump that is arranged adjacent to or directly surrounding said sleeve. Preferably, the thermal conductivity of the sleeve material has a value that is more than circa 50 times, preferably more than circa 100 times, in particular more than circa 200 times, at least though circa 5.5 times lower than the value of the thermal conductivity of at least the part of the high-pressure fuel injection pump adjacent to or directly surrounding said sleeve. Advantageously, at least a part of the sleeve is coated with a thermally insulating material. By using a sleeve design, in particular with the material and coating, characteristics mentioned above, a very simple, inexpensive and effective design of such a thermal insulation of the critical part of the suction channel from the remaining part of said high-pressure fuel injection pump can be achieved that ensures the wanted reliable control of fuel density at the inlet port of the at least one plunger of the high-pressure fuel injection pump and the wanted reliable and robust pump output controllability.

In a second aspect of the invention, a fuel injection system for an internal combustion engine is proposed that comprises a high-pressure fuel injection pump according to the first aspect of the an aspect of invention. In order to make such a system even more robust in its operation and to reduce any amounts of vaporized fuel in the system, a bleed valve is connectively arranged at the suction channel of the high-pressure fuel injection pump. Advantageously, said bleed valve is connectively arranged between the suction channel and a fuel return line connected to a fuel tank that retains the fuel collected in the fuel return line. Preferably, this tank is the same fuel tank from which the fuel for the high-pressure fuel injection pump is supplied thereby enabling an effective re-circulation of fuel that is not processed by the at least one plunger of the high-pressure fuel injection pump and consequently a corresponding reduction in overall fuel consumption. In a preferred embodiment of an aspect of the invention, the bleed valve can be electronically controlled to open when the suction channel is likely to contain fuel vapour, for instance when a hot internal combustion engine has to be started in very cold ambient conditions. The bleed valve can stay open for a relatively short time period to let the colder fuel displace the fuel vapour back to the fuel return line.

According to a third aspect of the invention, a fuel injection system for an internal combustion engine is proposed, which system comprises a high-pressure fuel injection pump for pressurizing fuel and delivering it for injection into the internal combustion engine, wherein said high-pressure fuel injection pump has an inlet (for receiving fuel from e.g. a fuel tank), at least one plunger (that pressurizes the received fuel and delivers it to injectors for injection into the internal combustion engine) and a suction channel positioned between the inlet and the at least one plunger (thereby connecting the inlet of the high-pressure fuel injection pump with the inlet port of the at least one plunger), and wherein a bleed valve is connectively arranged at said suction channel of the high-pressure fuel injection pump. Advantageously, said bleed valve is connectively arranged between the suction channel and a fuel return line connected to a fuel tank that retains the fuel collected in the fuel return line. This solution is particularly useful when a thermal insulation of the suction channel (or a part of it) from the remaining part of said high-pressure fuel injection pump according to the first aspect of the invention is not possible or to complex in its design or to costly to achieve.

Preferably, the tank is the same fuel tank from which the fuel for the high-pressure fuel injection pump is supplied thereby enabling an effective re-circulation of fuel that is not processed by the at least one plunger of the high-pressure fuel injection pump and consequently a corresponding reduction in overall fuel consumption. In a preferred embodiment of an aspect of the invention, the bleed valve can be electronically controlled to open when the suction channel is likely to contain fuel vapour, for instance when a hot internal combustion engine has to be started in very cold ambient conditions. The bleed valve can stay open for a relatively short time period to let the colder fuel displace the fuel vapour back to the fuel return line.

### BRIEF DESCRIPTION OF THE DRAWINGS

The present invention together with the above-mentioned and other objects and advantages may be best understood from the following detailed description of preferred embodiments of the invention, but is not restricted to these embodiments, wherein it is shown schematically:

FIG. 1 a preferred first embodiment of the fuel injection system according to an aspect of the present invention, with a high-pressure fuel injection pump being equipped with an advantageous thermal insulation (in form of a sleeve) of a part of the suction channel according to an aspect of the present invention;

FIG. 2 a preferred second embodiment of the fuel injection system according to an aspect of the present invention, with a high-pressure fuel injection pump being equipped with an advantageous thermal insulation (in form of a sleeve) of a part of the suction channel according to an aspect of the present invention and with an additional bleed valve connected to a fuel return line.

### DETAILED DESCRIPTION

In the Figures, equal or similar elements are referred to by equal reference numerals. The Figures are merely schematic representations, not intended to portray specific parameters of aspects of the invention. Moreover, the Figures are intended to depict only typical embodiments of aspects of the invention and therefore should not be considered as limiting the scope of the invention.

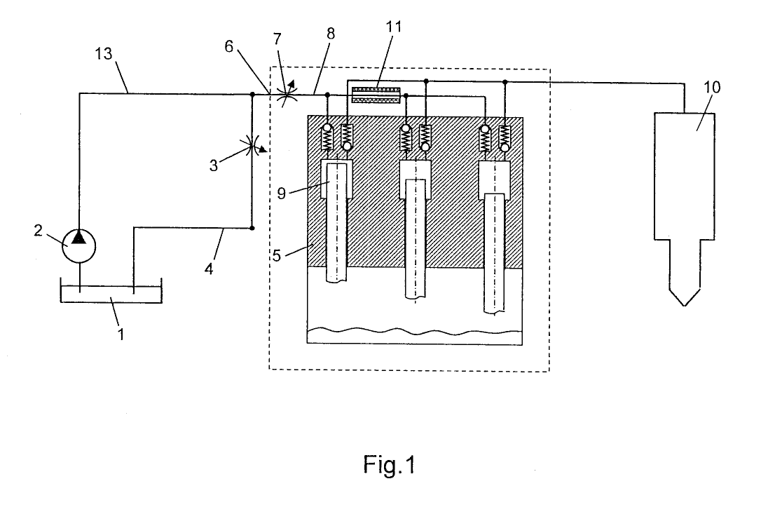

In FIG. 1, a preferred embodiment of the fuel injection system according to an aspect of the present invention is shown. The system comprises a fuel tank 1, a low-pressure fuel feed subsystem consisting of or comprising a feed pump 2, a restrictor valve 3, a fuel supply line 13 and a fuel return line 4. Further, the system comprises a high-pressure fuel injection pump 5 with an inlet 6, an inlet metering valve (IMV) 7, a suction channel 8 and exemplary three plungers 9, and a fuel injector 10 injecting the pressurized fuel into the internal combustion engine shown). The restrictor valve 3, the IMV 7 and the injector 10 are controlled by an engine management system (EMS) (not shown). In the Figure, a high-pressure fuel injection pump with 3 plungers 9 is shown which plungers 9 are phase-shifted in their pumping operation cycles.

However, it is understood that the selection of just 3 plungers 9 is only an example. In actual fact the number of plungers in such a pump may vary depending on the application and the special conditions. Pumps with one, two, three, four, five, six or even more than six plungers can be used in connection with aspects of the invention.

At least a part of the suction channel 8 is made in form of a relatively large-diameter hole in the high-pressure fuel injection pump 5, and in that hole a sleeve 11 made of a thermally insulating material is inserted.

The sleeve 11 may cover the inner side of the hole only at a certain part of a certain length (as exemplary shown in the Figure) or the hole in its complete length. Alternatively, more than one sleeve could be inserted into the hole to cover the inner side of the hole on certain (possibly separated) parts of certain (and possibly different) lengths. Still further, the sleeve(s), or any other thermal insulation, may even cover further parts of the suction channel 8 outside the hole or the complete suction channel 8 between the IMV 7 and the inlet ports of the plungers 9.

The inner diameter of the sleeve 11 is chosen such that the flow area of the sleeve 11 (the inner tube of the sleeve 1 characterized by the inner diameter) is sufficiently large for the high-pressure fuel injection pump 5 to reach its maximum desist flow output without restricting the inlet to the plungers 9, but otherwise is at a minimum in order to keep the total volume of the suction channel 8 as small as possible for good controllability of the fuel density in said suction channel 8.

The fuel injection system in FIG. 1 works in the following way: the feed pump 2 draws fuel from the fuel tank 1 and pressurizes it to a certain feed pressure. This feed pressure is supplied via the fuel supply line 13 to both the IMV 7 and the restrictor valve 3. The restrictor valve 3 is preferably controlled by the EMS to achieve the required fuel feed pressure, while the feed pump 2 supplies fuel flow in excess of the amount required for power generation by the internal combustion engine. That excess amount of fuel flow is re-circulated back via the fuel return line 4. The re-circulation fuel flow, thereby established, helps keeping the fuel temperature relatively uniform throughout the feed pressure circuit so that local hot spots and vaporisation of fuel are with a high probability avoided, ensuring stable fuel properties at the inlet of the IMV 7.

The fuel at feed pressure is then admitted through the IMV 7 to the suction channel 8 and further to the inlet ports of the three pumping plungers 9 that are phase-shifted in their pumping operation cycles, as shown in the Figure. On the downward stroke, the plungers 9 fill in the mass of fuel that depends on the EMS-controlled restriction of the IMV 7, and then pump it out of the high-pressure fuel injection pump 5 and into the injector 10 for injecting it into the internal combustion engine. The thermally insulating sleeve 1 slows down the rate of change of fuel properties (temperature, density etc.) that occurs in the suction channel 8 due to heating of the fuel by the hot body of the high-pressure fuel injection pump 5, and therefore reduces the risk of vapour formation in the suction channel 8 that can be high during critical operating conditions such as a very low load operation at a low speed directly after high speed/high load operation of the internal combustion engine, when the internal combustion engine and pump body parts of the high-pressure fuel injection pump 5 are at, or close to, their temperature maximum and the supply of fresh and cold fuel to the suction channel 8 is at, or close to, its temperature minimum.

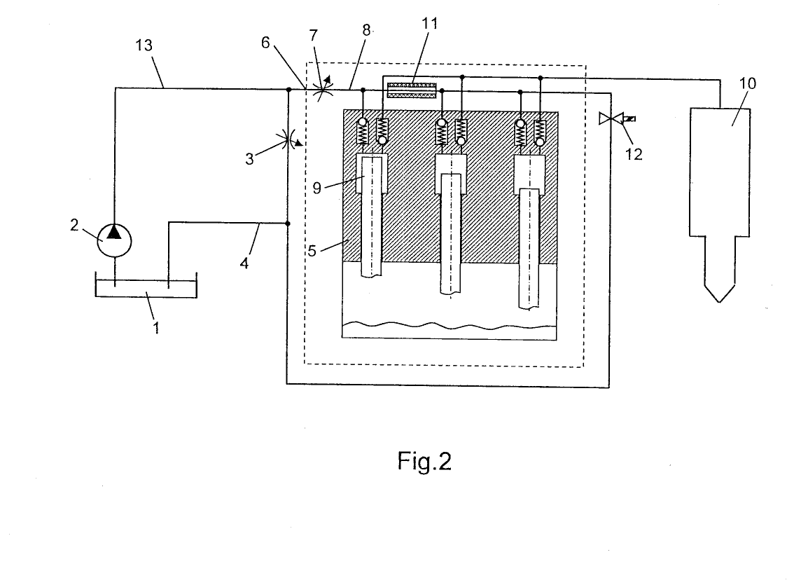

In FIG. 2, a preferred second embodiment of the fuel injection system according to an aspect of the present invention is shown. In addition to the system shown in FIG. 1, the system in FIG. 2 shows a bleed valve 12 that is arranged at the suction channel 8, the outlet of the bleed valve 12 being connected to the fuel return line 4. When the internal combustion engine and the high-pressure fuel injection pump 5 are particularly hot but the fuel in the fuel tank 1 is relatively cold such that the pressure in the fuel tank 1 is low and the feed pump 2 does not provide enough pressure to liquefy the vapour in the suction channel 8, the bleed valve 12 opens for a limited time to bleed the vapour out to the fuel return line 4 and to allow the fill up of the suction channel 8 with fresh colder (liquid) fuel. This will assist in, for example, starting up a hot engine in cold ambient conditions.

The above description is provided for reference, and the present invention can be constructed in many different versions and variants within the scope of the claims.

1. A fuel injection system for an internal combustion engine, comprising
a high-pressure fuel injection pump for pressurizing fuel and delivering it for injection into the internal combustion engine, the high-pressure fuel injection pump having an inlet, at least one plunger and a suction channel positioned between the inlet and the at least one plunger, and
a bleed valve connectively arranged at the suction channel of the high-pressure fuel injection pump.

2. A fuel injection system according to claim 1, wherein the bleed valve is connectively arranged between the suction channel and a fuel return line connected to a fuel tank.

3. A fuel injection system according to claim 1, wherein an inlet metering valve is connectively arranged at the inlet port of the high-pressure fuel injection pump.

4. A fuel injection system according to claim 2, wherein an inlet metering valve is connectively arranged at the inlet port of the high-pressure fuel injection pump.
